(19) United States
(12) Patent Application Publication
(10) Pub. No.: US 2010/0088963 A1
(43) Pub. Date: Apr. 15, 2010

(54) CEILING DRIVING UNIT FOR MOVING DOORS

(75) Inventor: Francesco Cevenini, Casalechio Di Reno (IT)

Correspondence Address: HEDMAN & COSTIGAN P.C., 1185 AVENUE OF THE AMERICAS, NEW YORK, NY, 10036, US

(73) Assignee: FAAC S.p.A., Zola Predosa (IT)

(21) Appl. No.: 12/448,127

(22) PCT Filed: Dec. 11, 2007
(86) PCT No.: PCT/EP2007/010835

§ 371 Date: Sep. 10, 2009

(30) Foreign Application Priority Data
Dec. 13, 2006 (IT) MI2006U000437

(51) Int. Cl. E05F 15/10; F16M 13/00

(52) U.S. Cl. 49/360; 248/205.1

(57) ABSTRACT

A ceiling driving unit for moving doors comprises a motor unit (12) arranged at the end of a running rail (11) for a door-dragging carriage (17). The motor unit has a driven axis (14) that engages a mechanism in the rail to transmit movement to the carriage and between the rail and motor unit there are mutual coupling means (26-27-28-29, 30-31-32-33) for connecting the motor unit to the rail and which are driven by manual rotation of the motor unit around the driven axis.

The present invention refers to a ceiling driving unit with rail for moving sectional or tilting doors.

Ceiling drives are known that consist of a motor unit and a rail that contains the movement mechanism to be connected to the door to be moved. Usually, such drives require a certain manual ability for mounting and entail a certain physical fatigue because of the need to fix the motor unit to the rail and to lift and fix the assembly to the ceiling with screws. Maintenance operations are also complicated as the motor unit is not readily removable from the ceiling. During mounting, there is also a certain risk of damaging the internal components of the motor unit, especially the electronic control cards, as it is often necessary to open the motor unit to be able to screw the motor unit to the ceiling.

The general object of the present invention is to overcome the aforesaid drawbacks by providing a ceiling driving unit that is easier and quicker to install.

In view of this object it was decided to devise, according to the invention, a ceiling driving unit for moving doors, comprising a motor unit arranged at the end of a sliding rail of a dragging carriage for dragging the door, the motor unit having a driven axis that engages a mechanism in the rail to transmit movement to the carriage, characterized in that between the rail and motor unit there are mutual coupling means for connecting the motor unit to the rail and that the coupling means is driven by manual rotation of the motor unit around the driven axis.

In order to make the explanation of the innovative principles of the present invention and the advantages thereof over the prior art clearer, with the help of the attached drawings a possible embodiment applying such principles will be disclosed below. In the drawings:

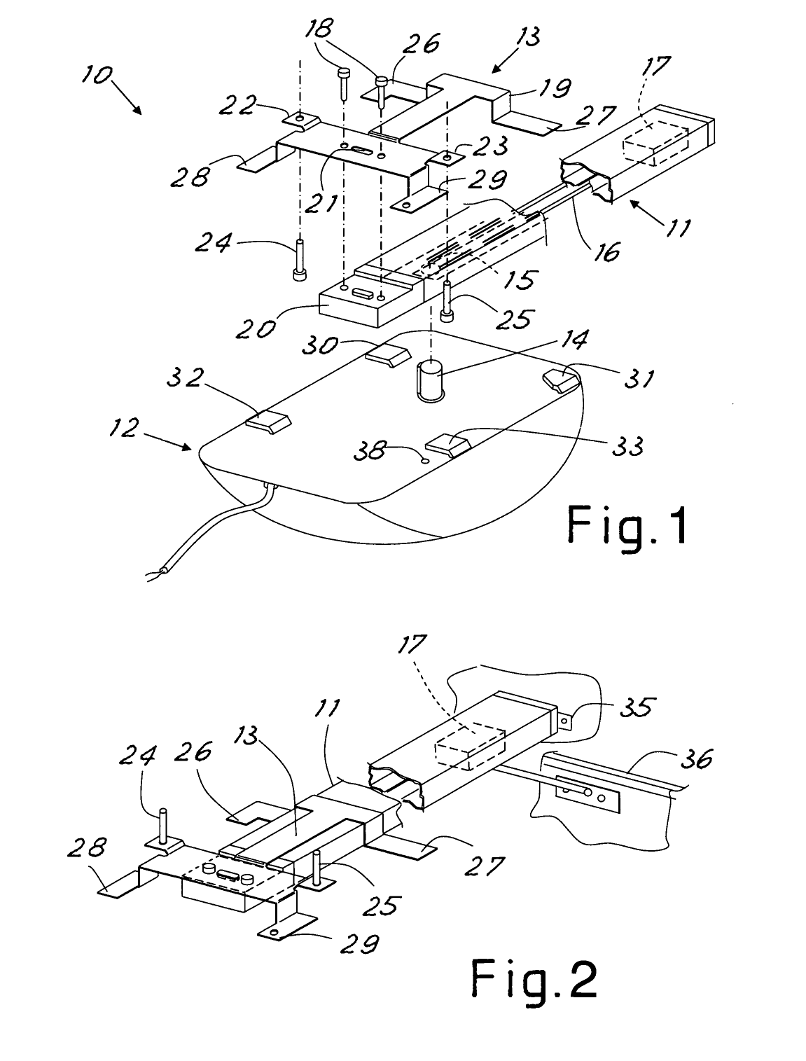

FIG. 1 is an exploded perspective view of a part of a driving unit made according to the invention;

FIG. 2 is a schematic perspective view of a partially mounted rail assembly of the driving unit in FIG. 1;

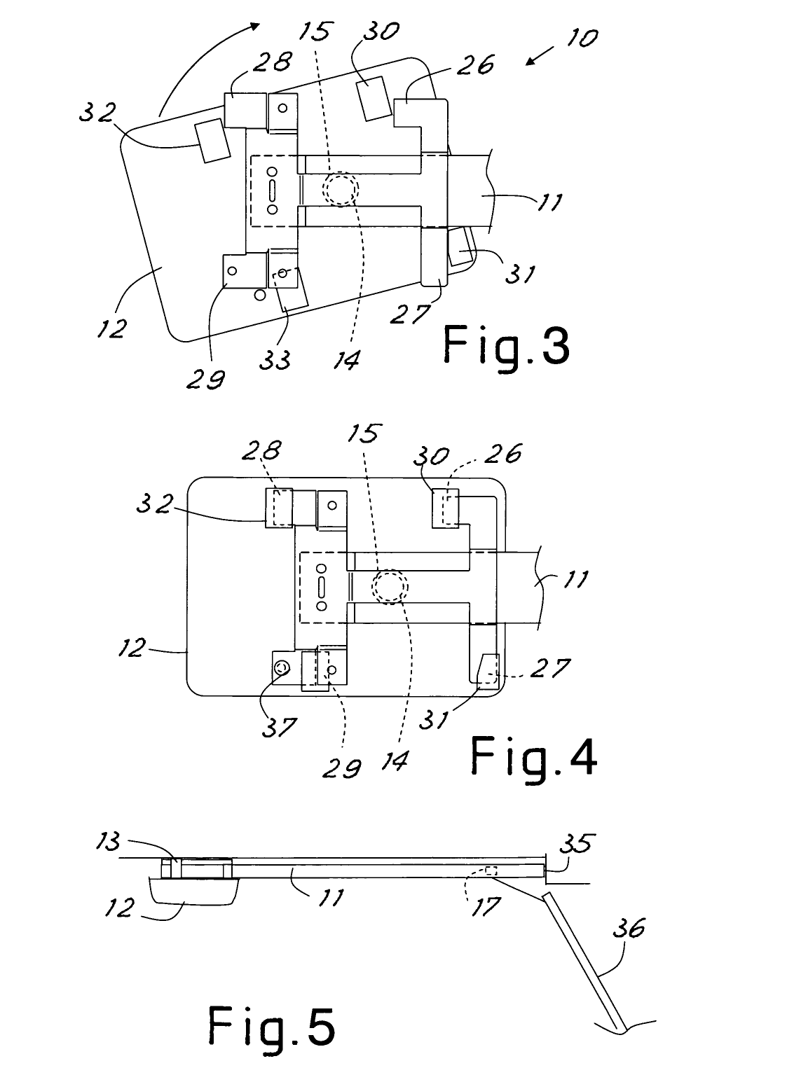

FIG. 3 is a plan view of an initial coupling step of the motor unit of the driving unit in FIG. 1;

FIG. 4 is a plan view of the motor unit of the driving unit in FIG. 1 in a coupled position;

FIG. 5 is a schematic raised side view of a driving unit according to the invention mounted in position.

With reference to the figures, in FIG. 1 there is shown a ceiling-mounted driving unit, generally indicated by 10, made according to the principles of the present invention. The driving unit comprises a rail 11, a motor unit 12 and a mounting bracket 13. The motor unit has a driven axis for transmitting motion to the rail. In the embodiment shown, from the motor unit 12 there protrudes a driven shaft 14 intended for insertion into a suitable transmission coupling element 15 for transmission motion to the movement mechanism inside the rail. As can be easily imagined by those skilled in the art, the movement mechanism in the rail can be of any known type. For example, the rail can provide a carriage 17 and a chain transmission system 16, with the chain moved by a sprocket 15 that couples with the shaft 14. At the opposite end of the rail there will be a suitable chain-relaying pulley (not shown) of the chain. The bracket 13, made of cut and folded metal sheeting, comprises fixing means located at the end of the rail that advantageously comprises a pair of screws 18 and a U-shaped coupling part 19 that grips the rail. In order to facilitate positioning, between the bracket and rail mutual position reference elements can be advantageously provided. For example, a template is advantageous that is represented by a shaped tooth 20 protruding from the end of the rail and which couples with a complementary seat 21 cut into the bracket. As can be seen in the figure, it has been found to be advantageous to make the bracket with a generally H-shaped plan shape, with the two arms of the H that are transverse to the extent of the rail and the central connecting part arranged on the upper face of the rail.

From the bracket 13 tabs 22, 23 protrude laterally that are intended to fix the bracket to the ceiling by means of suitable screws 24, 25 (for example that are inserted into screw anchors, which are not shown). The fixing tabs 22, 23 advantageously protrude laterally from the bracket part intended to be screwed to the rail so as to prevent excessive flexing moments on the bracket. For fixing to the ceiling, spacing rods (not shown) can also be provided. The tabs 22, 23 (or additional tabs, which are not shown) can be folded vertically to fix the rods.

Between the bracket and the motor unit there are mutual coupling means that operate by rotating the motor unit around the driven axis.

In particular, the bracket is shaped also to define four coupling tabs 26, 27, 28, 29 on a plane that is transverse to the driven axis and which are arranged for coupling, with rotational movement around the shaft 14, as will be clear below, in four suitable seats 30, 31, 32, 33 located on the upper face of the motor unit.

In FIG. 2 there is shown the bracket coupled with the rail. It is seen how the coupling tabs are arranged at the end of U parts of the bracket, so as to move to the rail plane that is coupled with the motor unit.

As the first mounting step of the driving unit, the bracket must be mounted on the rail (this can be done comfortably on the ground), grasping the driving unit from the side opposite that intended to receive the motor unit, and then the bracket-rail assembly must be fixed to the ceiling with the screws 24, 25. The other end of the rail will be fixed above the door to be driven by means of suitable known means 35 and the carriage 17 will be connected to the door 36 according to known technique. The door may naturally be of various types, such as a tilting or sectional door, as those skilled in the art can easily imagine.

After assembling the rail and bracket assembly, it is sufficient to move the motor unit near to insert the motor shaft in the seat in the rail as shown in FIG. 3 and then rotate the motor shaft from a position that is angled with respect to the axis of the rail as far as the operating position that is parallel to the rail and complete coupling of the tabs 26, 27, 28, 29 in the seats 30, 31, 32, 33, as can be seen in FIG. 4. The seats are suitably open with a lateral incision for introducing the tabs. Once the motor unit has been rotated in the operating position thereof shown in FIG. 4, a locking pin 37 that passes one of the suitably drilling coupling tabs, and couples in a corresponding hole 38 in the motor unit, in such a way as to prevent opposite disassembly rotation can be advantageously inserted. Lastly, the electrical connections can be wired.

In FIG. 5 there is shown schematically the driving unit that is completely mounted on the ceiling and connected to a tilting door (in a slightly open position).

At this point it is clear how the preset objects have been achieved by providing a ceiling driving unit that it is easy to mount. During fixing of the motor unit, the motor unit, which is in general very heavy, can be comfortably held in two hands, as no tools are necessary for the operation. Owing to the fact that the motor unit does not have to be opened to be fixed to the rail and to the ceiling possible internal damage that could occur during mounting in traditional drives is avoided. Further, the need for tools is minimized and future after-sales care is facilitated, the motor unit being easily removable, replaceable and refittable.

Naturally, the above description of an embodiment applying the innovative principles of the present invention is provided by way of example of such innovative principles and must not therefore be taken to limit the protective scope of what is claimed herein. For example, the motor unit may contain, in addition to the electric motor, all the electronics necessary for the operation thereof (for example, in addition to a control unit also a radio remote control system). The sprocket of the rail mechanism can also be provided with a protruding shaft for coupling with a driven seat of the motor unit and not vice versa.

1. Ceiling driving unit for moving doors, comprising a motor unit (12) arranged at the end of a running rail (11) for a door-dragging carriage (17), the motor unit having a driven axis (14) that couples with a mechanism in the rail to transmit movement to the carriage, characterized in that between the rail and motor unit there are mutual coupling means (26-29, 30-33) for connecting the motor unit to the rail and that they are driven by manual rotation of the motor unit around the driven axis.

2. Driving unit according to claim 1, characterized in that the mutual coupling means comprise a bracket (13) connected to the rail and is provided with coupling tabs (26-29) that protrude on a plane that is transverse to the driven axis to couple in suitable seats (30-33) in the motor unit at the rotation of the motor unit around the driven axis from an angled position to an operating position aligned on the rail.

3. Driving unit according to claim 3, characterized in that the bracket also comprises tabs (22, 23) for fixing the bracket to the ceiling together with the rail.

4. Driving unit according to claim 2, characterized in that the bracket is shaped to grasp the rail on the side opposite the motor unit.

5. Driving unit according to claim 2, characterized in that the bracket has a generally H-shaped plan shape with the two arms of the H that are transverse to the extent of the rail to carry the coupling tabs and the central connecting part that is arranged on the upper face of the rail.

6. Driving unit according to claim 2, characterized in that the bracket is screwed to the end of the rail.

7. Driving unit according to claim 6, characterized in that between the bracket and the rail there are mutual position reference elements.

8. Driving unit according to claim 7, characterized in that the mutual position reference elements comprise a shaped tooth (20) protruding from the rail and which couples in a complementary seat (21) cut into the bracket.

9. Driving unit according to claim 2, characterized in that between the rail bracket and motor unit a pin (37) locking disassembly is couplable.

10. Driving unit according to claim 2, characterized in that the bracket is made of cut and folded sheet metal.
